(19) United States
(12) Patent Application Publication
(10) Pub. No.: US 2025/0382733 A1
(43) Pub. Date: Dec. 18, 2025

(54) MINERAL FIBER MAT BASED ON A BINDER COMPRISING AMINO ACID POLYMER AND ALPHA-HYDROXY CARBONYL COMPOUND

(71) Applicant: BASF SE, Ludwigshafen am Rhein (DE)

(72) Inventors: Stephan WEINKOETZ, Ludwigshafen am Rhein (DE); Holger SCHILLING, Ludwigshafen am Rhein (DE); Gereon Antonius SOMMER, Ludwigshafen am Rhein (DE)

(21) Appl. No.: 18/875,792

(22) PCT Filed: Jun. 19, 2023
(86) PCT No.: PCT/EP2023/066483

§ 371 Date: Dec. 17, 2024

(30) Foreign Application Priority Data
Jun. 22, 2022 (EP) 22180564.1

(51) Int. Cl. D04H 1/4209; D04H 1/50; D04H 1/587

(52) U.S. Cl. CPC D04H 1/4209; D04H 1/50; D04H 1/587; D10B 2101/02; D10B 2505/12

(57) ABSTRACT

The invention relates to a process for producing a mineral fiber mat. The mineral fiber mat comprises a mineral fiber component A comprising minerals fibers selected from stone fibers, glass fibers, and mixtures thereof, and a cured binder component B. Cured binder component B is prepared by curing, at a temperature in a range of from 80 to 250° C., of a binder mixture comprising as binder constituents c1) one or more amino acid polymers having two or more primary amino groups and c2) one or more alpha-hydroxy carbonyl compounds. The invention further relates to the mineral fiber mat and a mineral fiber composite mat. The mats of the invention are used as or in a construction product, or in a transportation vehicle.

The present invention relates to a process for preparing a mineral fiber mat. Furthermore, the invention relates to a mineral fiber mat and a mineral fiber composite mat, and the use of the mineral fiber mat and the mineral fiber composite mat as or in a construction product or a transportation vehicle.

Mineral fiber mat products are widely used for the thermal and sound insulation of buildings (such as floors and roofs) and of transportation vehicles. They provide for excellent fire protection. Mineral fiber mats typically contain mineral fibers with varying lengths, which are bound by a synthetic resin-based binder. Processes for the production of mineral fiber mats typically comprise the steps of 1) melting the mineral material, 2) fiberizing the molten mixture into fine fibers, 3) application (e.g. spraying) of a binder mixture to the fibers, collection of the binder-fibers and formation of a primary fleece on a conveyor, densifying the fleece, and curing the binder at elevated temperatures. The cured mat is then cut to the desired size and optionally rolled up, before it is packaged for transport to the site of further use.

There is a demand in industry for an improved process of producing mineral fiber mats, wherein binder constituents can be used that can be obtained to the highest possible extent from non-petrochemical, preferably from renewable, resources and that are suitable to reduce or avoid potentially hazardous substances like formaldehyde and isocyanates or substances that emit formaldehyde, during or after the production process of the composites, like e.g. N-methylol compounds.

EP 2 914 071 B1 teaches curable formaldehyde-free resin dispersions for the manufacture of mineral fiber products. The curable resin comprises an aqueous dispersion of a) a water-insoluble native starch, b) polycarboxylic polymer, and c) non-polymeric polycarboxylic acid compound.

WO2011/138458A teaches a binder formulation and materials made therewith comprising a carbohydrate-based binder, in particular a binder comprising the reaction products of a carbohydrate reactant and a polyamine.

EP 2 634 221 A teaches binder compositions where the compositions include a protein, a first crosslinking compound that includes a carbohydrate, and a second crosslinking compound that includes two or more primary amine groups. Because proteins are insoluble in water, these binder compositions cannot be formulated freely.

According to WO 2018/190662 A2 (EP 3 611 225 A2), a binder composition comprises polylysine and at least one reducing sugar. The polylysine mentioned exhibits, in a 1H NMR spectrum, a first peak at 3.2 ppm to 3.4 ppm and a second peak at 3.8 ppm to 4.0 ppm, wherein a ratio (A:B) of an area of the first peak (A) to an area of the second peak (B) is 70:30 to 98:2. In a method of manufacturing an article, the binder composition may further include a variety of materials, such as a fibrous material or a powdered material.

US 20160304705 teaches binder compositions comprising diamine (such as hexamethylenediamine, HMDA, and ethylenediamine) and sugars (such as glucose). EP 2 885 116 B1, WO2013/150123A1 and WO 2015/177114 A1 (U.S. Pat. No. 11,332,577 B2) teach binder compositions comprising diamine (such as HMDA and lysine) and sugars (such as glucose, fructose and xylose). WO2017/207355 A1 teaches binder compositions comprising polyamine (such as polyethyleneimine, triethylene tetramine, HMDA, ethylene diamine, or lysine) and sugar (such as glucose and xylose).

However, there continues to be a need for binder compositions for mineral fiber mats having a high content in non-petroleum-derived binder resin material. The binder compositions should provide favourable properties to the resultant mineral fiber mats, i. e. without deterioration of the mechanical properties of the mats. Moreover, the binder material should have limited yellowing during curing, so that the final mineral fiber mats do not necessarily have a dark or brown colour. Also, the binder material when cured should have limited solubility in water, so as to restrict weight loss and consequential mechanical property deterioration of the mineral fiber mat when (inadvertently) exposed to water.

It has now been found that these problems are solved when following the process according to the present invention. In particular, it has been found that the use of amino acid polymers improves (namely lowers) yellowing when curing the binder compositions according to the present invention, as compared to the use of diamines and triamines as in the prior art. Moreover, the use of specific alpha-hydroxy carbonyl compounds (such as hydroxy acetone) further improves yellowing, as compared to the use of sugars as in the prior art. The binder constituents ensure that the mineral fiber mat of the invention does not release undesirable chemicals, such as phenol or formaldehyde.

In a first aspect, the present invention relates to a process for preparing a mineral fiber mat.

In a second aspect, the invention relates to the mineral fiber mat.

In a third aspect, the invention relates to the mineral fiber composite mat.

In a fourth aspect, the invention relates to the use of the mineral fiber mat or the mineral fiber composite mat as or in a construction product, or in a transportation vehicle.

The invention as well as preferred variants and preferred combinations of parameters, properties and elements thereof are defined in the appended claims. Preferred aspects, details, modifications and advantages of the present invention are also defined and explained in the following description and in the examples shown below.

If not stated otherwise, preferred embodiments, aspects or features of the present invention can be combined with other embodiments, aspects or features, especially with other preferred embodiments, aspects or features, irrespective of the categories to which the embodiments, aspects or features relate. The combination of preferred embodiments, aspects or features with other preferred embodiments, aspects or features in each case again results in preferred embodiments, aspects or features. In the following detailed discussion of the invention, each statement (e.g. in the context of the process of the invention) regarding a preferred embodiment in terms of the binder constituents in particular equally applies to the mineral fiber mat (in particular the mineral fiber wool mat) and the mineral fiber composite mat.

### DETAILED DISCLOSURE

The process for preparing a mineral fiber mat according to the first aspect of the invention comprises the following steps:
i. bringing mineral fibers selected from stone fibers, glass fibers, and mixtures thereof, in contact with a binder mixture comprising as binder constituents
   c1) one or more amino acid polymers having two or more primary amino groups, and
   c2) one or more alpha-hydroxy carbonyl compounds,
and
ii. curing the binder mixture at a temperature in a range of from 80 to 250° C., to give the mineral fiber mat.

The mineral fiber mat as prepared with the process according to the first aspect of the invention preferably comprises
i. 90 to 98% by weight of mineral fiber component A, and
ii. 2 to 10% by weight of cured binder component B.

According to the invention, the binder mixture preferably comprises
binder constituent c1) in a total amount in the range of from ≥30 to ≤90 wt.-%, relative to the totalized weight of binder constituents c1) and c2), and
binder constituent c2) in a total amount in the range of from ≥10 to ≤70 wt.-%, relative to the totalized weight of binder constituents c1) and c2).

The process for preparing a mineral fiber mat according to the first aspect of the invention preferably comprises the following steps:
i. bringing mineral fibers selected from stone fibers, glass fibers, and mixtures thereof, in contact with a binder mixture comprising as binder constituents
   c1) one or more amino acid polymers having two or more primary amino groups, and
   c2) one or more alpha-hydroxy carbonyl compounds,
wherein the binder mixture comprises
   binder constituent c1) in a total amount in the range of from ≥30 to ≤90 wt.-%, relative to the totalized weight of binder constituents c1) and c2), and
   binder constituent c2) in a total amount in the range of from ≥10 to ≤70 wt.-%, relative to the totalized weight of binder constituents c1) and c2)
and
ii. curing the binder mixture at a temperature in a range of from 80 to 250° C., to give the mineral fiber mat.

In a preferred embodiment of all aspects of the invention, the mineral fiber material is glass fibers. As used herein, the term “glass fiber” in particular comprises a material comprising 62 to 66% by weight of SiO₂, 1 to 3% by weight of Al₂O₃, 18 to 21% of Na₂O and/or K₂O, 8 to 10% by weight of CaO and/or MgO, 5 to 7% by weight of B₂O₃, less than 1% by weight of other oxides, and that is essentially free from iron and titanium oxides.

In a further preferred embodiment of all aspects of the invention, the mineral fiber material is stone fibers. As used herein, the term “stone fiber” in particular comprises a material comprising 33 to 43% by weight of SiO₂, 18 to 24% by weight of Al₂O₃, 1 to 10% of Na₂O and/or K₂O, 1 to 10% by weight of CaO and/or MgO, 23 to 33% by weight of FeₓO_{y}, and 1 to 3% by weight of TiO₂, less than 3% by weight of other oxides, and that is essentially free from boron oxide.

In a typical embodiment and when using glass fibers or stone fibers, molten raw materials from a furnace are shaped into fibers by using cascade spinning (for glass fibers) or rotary spinning devices (for stone fibers). Right after fiber spinning, and in order to keep the single fibers together, a binder mixture is added onto the fibers by spraying. The binder-sprayed fibers are then collected on a belt, to form a fiber mat. Final stability and shape are provided to the mat in a curing oven at around 200° C. The process allows for calibration of both structure and density of the final mat product, to fit the required performance of the specific product application.

As used herein the term “amino acid polymer(s) having two or more primary amino groups” (of constituent c1) of the binder composition) designates a polymer compound which is a polymerization product of amino acids and optionally other monomers (wherein the monomers of the polymer compound are preferably connected with or bound to each other via amide bonds), selected from the group consisting of
a) amines comprising at least two amino groups, wherein the amines are not amino acids, and
b) organic compounds having at least two carboxyl groups, preferably selected from the group consisting of organic dicarboxylic acids and organic tricarboxylic acids, wherein the organic compounds having at least two carboxyl groups are not amino acids,

wherein preferably at least 50 wt.-%, more preferably at least 75 wt.-%, most preferably at least 85 wt.-%, in particular at least 90 wt.-%, such as at least 95 wt.-%, preferably at least 97.5 wt.-%, more preferably at least 99 wt.-%, most preferably 100 wt.-%, amino acids are used as monomers for the polymerization reaction based on the total amount of monomers forming the amino acid polymer(s) having two or more primary amino groups.

Generally and for the purpose of the present invention, said amino acid polymer(s) having two or more primary amino groups may comprise or consist of dimers (n=2), trimers (n=3), oligomers (n=4-10) and/or macromolecules (n>10), wherein n is the number of monomers which have been reacted to form the dimers, trimers, oligomers and macromolecules of the amino acid polymer(s) having two or more primary amino groups.

The skilled person will select the monomers for producing said amino acid polymer(s) having two or more primary amino groups so as to receive desired amino acid polymer(s) having two or more primary amino groups.

As used herein, the term “amino acid polymer(s) having two or more primary amino groups” also includes derivatives, which are obtained by modification of the amino acid polymer(s) having two or more primary amino groups after polymer synthesis. Said modifications may be performed by reaction with the following reagents:
i) alkyl- or alkenylcarboxylic acids, such as for example octanoic acid, nonanoic acid, decanoic acid, dodecanoic acid, hexadecenoic acid, stearic acid, oleic acid, linoleic acid and/or linolenic acid and/or or their Li, Na, K, Cs, Ca or ammonium salts, and/or
ii) polyalkylene oxides which are terminated by amino groups and/or acid groups and have a functionality of one, two or more, preferably polyethylene oxides, polypropylene oxides and/or polyethylene-propylene oxide, and/or
iii) alkylene oxides, such as ethylene oxide, propylene oxide and/or butylene oxide and/or
iv) lactones, e.g. epsilon-caprolactone, delta-valerolactone, gamma-butyrolactone and/or
v) alcohols, such as alkanoles, for example oleyl alcohol.

Amino acid(s) which may be present as monomers in the amino acid polymer(s) having two or more primary amino groups are organic compounds comprising at least one primary amine (—NH₂) functional group and at least one carboxyl (—COOH) functional group. Said amino acid(s) are preferably selected from the group consisting of lysine, histidine, isoleucine, leucine, methionine, phenylalanine, threonine, tryptophan, valine, arginine, aspartic acid, glutamic acid, serine, asparagine, glutamine, cysteine, selenocysteine, glycine, alphaalanine, beta-alanine, tyrosine, gamma-aminobutyric acid, epsilon-aminocaproic acid, ornithine, diaminopimelic acid, 2,3-diaminopropionic acid, 2,4-diaminobutyric acid or mixtures thereof. The amino acids can be used in their L- or D- or racemic form. The amino acids may also be used in their cyclic lactam form, e.g. epsilon-caprolactam.

Preferred amino acids which are used for the polymerization reaction (as monomers for forming said amino acid polymer(s) having two or more primary amino groups) are diamino acids, comprising two amine groups, preferably two primary amine groups (—NH₂), and at least one carboxyl (—COOH) group. Such diamino acids are preferably selected from the group consisting of ornithine, diaminopimelic acid, 2,3-diaminopropionic acid, 2,4-diaminobutyric acid and lysine. Lysine is preferred as amino acid monomer for forming said amino acid polymer(s) having two or more primary amino groups. L-lysine is even more preferred for this purpose.

Said amino acid polymer(s) having two or more primary amino groups can be linear or branched or partially linear and partially branched.

Preferred amino acid polymer(s) having two or more primary amino groups for the purpose of the present invention are described below.

As used herein, the term “alpha-hydroxy carbonyl compounds” (of constituent c2) of the binder composition) designates compounds that are capable of reacting with amine compounds, and optionally further compounds, in order to form a hardened binder.

For use in the binder composition in constituent c2) such alpha-hydroxy carbonyl compound(s) must be capable of reacting with the amino acid polymers having two or more primary amino groups used in constituent c1).

The binder composition comprises as constituents, preferably for hardening the binder or binder composition, constituents c1), one or more amino acid polymers having two or more primary amino groups, and c2), one or more one or more alpha-hydroxy carbonyl compounds. Constituents c1) and c2) are also referred to herein as “curable constituents”, preferably as “heat-curable constituents” of the binder or binder composition. More specifically, constituents c1) and c2) are also referred to herein collectively as “binder”, and separately as “curable constituents”, preferably as “heat-curable constituents”, of the binder.

Binder constituent c1) preferably comprises one or more polylysines. The one or more polylysines preferably have a weight-average molecular weight M_{w} of ≥800 g/mol, preferably of ≥1,000 g/mol, more preferably of 1,500 g/mol.

The one or more polylysines preferably have a weight-average molecular weight M_{w} of ≤10,000 g/mol, preferably of ≤5,000 g/mol, more preferably of ≤4,000 g/mol.

The one or more polylysines preferably have a weight-average molecular weight M_{w} in the range of 800 g/mol≤M_{w}≤10,000 g/mol, preferably of 1,000 g/mol≤M_{w}≤8,000 g/mol, more preferably of 1,500 g/mol≤M_{w}≤5,000 g/mol and yet more preferably of 1,800 g/mol≤M_{w}≤4,000 g/mol.

The one or more polylysines preferably comprise as monomers integrated in their polymer structure at least 85 wt.-%, preferably at least 95 wt.-%, more preferably at least 99 wt.-%, and yet even more preferably 100 wt.-%, of lysine monomers, based on the total weight of monomers forming the polylysine. In this formal calculation regarding the amino acid (lysine) polymer of constituent c1), as preferably prepared by condensation of lysine, the release of water in the condensation from the amino acid is disregarded.

The binder mixture may also comprise lysine monomer.

In the one or more polylysines, preferably at least 50 wt.-%, preferably at least 75 wt.-%, preferably at least 85 wt.-%, more preferably at least 90 wt.-%, most preferably at least 95 wt.-%, in particular at least 97.5 wt.-%, such as at least 99 wt.-%, even more preferably 100 wt.-%, amino acids are used as monomers for the polymerization reaction based on the total amount of monomers forming the amino acid polymer(s) having two or more primary amino groups.

In the amino acid polymers of constituent c1) of the invention, monomeric amino acid units with two amino groups (diamino acids, which are preferably L-lysine units) are connected to one another at least partially in omega fashion (in the case of case of lysine, epsilon fashion), leading to a polymer with diamino acid units which are connected partially in alpha fashion and partially in omega fashion.

Preferably, the ratio of ε-linkages to α-linkages in the polylysine as most preferred as constituent c1) in all aspects of the invention (“ratio ε/α”) is preferably in the range of from 0.5 to 8, more preferably from 1.2 to 5, such as from 1.4 to 4, in particular from 1.5 to 3.5, such as from 1.7 to 3.0.

Preferably, the wt.-% proportion (weight percentage) of lysine (monomers), preferably of L-lysine, in the one or more polylysines can be determined in a manner known per se, e.g. by complete hydrolysis of the polylysine and subsequent analysis of the resulting monomers by HPLC/MS.

Weight-average molecular weights M_{w} of the one or more amino acid polymers having two or more primary amino groups, including of polylysines, are preferably determined by size exclusion chromatography (SEC), as is generally known in the field.

Said one or more polylysines can be linear or branched or partially linear and partially branched.

As used herein, the term “polysine(s)” designates a polymerization product of the monomer lysine, preferably of L-lysine, and optionally further monomers selected from the group consisting of
a) amino acids,
b) amines comprising at least two amino groups, wherein the amines are no amino acids,
and
c) dicarboxylic acids, which are no amino acids, and tricarboxylic acids, which are no amino acids,
wherein preferably
the proportion of lysine in wt.-%, which is used as monomer for the polymerization reaction for producing the polylysine, based on the total amount of monomers used for the polymerization of the polylysine, is ≥10 wt.-%, preferably 20 wt.-%,
or
at least 50 wt.-%, preferably at least 75 wt.-%, preferably at least 85 wt.-%, preferably at least 95 wt.-%, more preferably at least 99 wt.-%, and yet even more preferably 100 wt.-%, of lysine, is used as the monomer for the polymerization reaction for producing said polylysine, based on the total amount of monomers used.

Preferred as polylysine(s) for the purpose of the present invention are homopolymers of lysine, preferably homopolymers of L-lysine.

Generally and for the purpose of the present invention, polylysine may comprise or consist of dimers (n=2), trimers (n=3), oligomers (n=4-10) and/or macromolecules (n>10), wherein n is the number of lysine monomers which have been reacted to form the dimers, trimers, oligomers and macromolecules of the polylysine(s). Additionally, lysine monomers may be present in a limited amount in a mixture with the polylysine, e.g. due to incomplete conversion of the monomers during the polymerization reaction for producing polylysine.

In the present text, the term polylysine preferably also includes polylysine derivatives, which are prepared by or can be prepared by a modifying reaction of (i) the amino groups present in the polylysine obtained by polymer synthesis with (ii) electrophiles like carboxylic acid, epoxides, and lactones, wherein the total amount of amino groups reacted in the modifying reaction is 20% or lower, preferably 10% or lower, based on the total amount of amino groups in the polylysine obtained in the polymer synthesis (i.e., before modification).

Binder constituent c2) preferably comprises one or more alpha-hydroxy carbonyl compounds selected from the group consisting of glycolaldehyde, glyceraldehyde, 1,3-dihydroxyacetone, hydroxyacetone, arabinose, xylose, glucose, mannose, and fructose,

It is preferred that the binder mixture comprises binder constituent c1) in a total amount in the range of from ≥40 to ≤85 wt.-% and preferably of from ≥45 to ≤80 wt.-%, relative to the totalized weight of binder constituents c1) and c2).

It is further preferred that the binder mixture comprises binder constituent c2) in a total amount in the range of from ≥15 to ≤60 wt.-% and preferably of from ≥20 to ≤55 wt.-%, relative to the totalized weight of binder constituents c1) and c2).

Moreover, it is preferred that the pH-value of the binder mixture is in the range of from 10 to 14, preferably of from 11 to 14, more preferably of from 12 to 14.

Preferably, the binder mixture further comprises binder constituent c3) a carrier liquid. It is most preferred that binder constituent c3) is water. Because binder constituents c1) and c2) are water-soluble, the use of any mandatory carrier liquid constituents specifically for bringing binder constituents c1) or c2) into solution can in accordance with the present invention be dispensed with.

The binder mixture further preferably comprises binder constituent c4) comprising one or more polyaldehyde compounds. More preferably, the binder mixture further comprises binder constituent c4) comprising one or more of oxidized starch, glyoxal, dialdehyde cellulose, propanedial, butanedial, pentanedial, hexanedial, furan-2,5-dicarbaldehyde, 3-hydroxy-2-oxo-propanal, and 5-(hydroxymethyl)furan-2-carbaldehyde. Most preferably, binder constituent c4) comprises one or more of glyoxal, furan-2,5-dicarbaldehyde, 5-(hydroxymethyl)furan-2-carbaldehyde, and mixtures thereof. It is in particular preferred that binder constituent c4) comprises or is 5-(hydroxymethyl)furan-2-carbaldehyde.

With respect to the amounts of mandatory constituents c1) and c2), these are given in respect of the total amounts of these constituents of the binder composition, before curing.

The mineral fiber mat of the second aspect of the invention comprises:
a mineral fiber component A comprising mineral fibers selected from stone fibers, glass fibers, and mixtures thereof, and
a cured binder component B prepared by curing, at a temperature in a range of from 80 to 250° C., of a binder mixture comprising as binder constituents
   c1) one or more amino acid polymers having two or more primary amino groups and
   c2) one or more alpha-hydroxy carbonyl compounds.

The mineral fiber mat according to the second aspect of the invention preferably comprises
i. 90 to 98% by weight of mineral fiber component A, and
ii. 2 to 10% by weight of cured binder component B.

According to the present invention, the mineral fiber mat preferably has a density in a range of from 20 to 200 kg/m³.

The mineral fiber mat may, e.g., have a thickness in a range of from 1 to 300 mm. Preferably, the mineral fiber mat is in the form of a mineral fiber wool mat, or a mineral fiber veil mat.

The mineral fiber mat of the invention, when in the form of a mineral fiber veil mat, preferably has a thickness in a range of from 1 to 5 mm, preferably 2 to 4 mm. Also, the mineral fiber veil mat may comprise
i. 75 to 95% by weight of mineral fiber component A, and
ii. 5 to 25% by weight of cured binder component B.

In the mineral fiber veil mat, the fibers may have a diameter in a range of from 6 to 12 μm.

The mineral fiber mat, when in the form of a mineral fiber veil mat, is preferably prepared by preparing a nonwoven web of the fiber material in a wetlaying process, and then spraying the binder mixture onto the wet web. Finally, the wetlaid web, having the binder mixture sprayed onto it, is cured.

The mineral fiber mat of the invention, when in the form of a mineral fiber wool mat, preferably has a thickness in a range of from 10 to 250 mm. It is preferred that the mineral fiber wool mat has a thickness in a range of from 80 to 240 mm, 30 to 60 mm, 60 to 240 mm, 40 to 100 mm, 100 to 180 mm, 40 to 150 mm, 15 to 40 mm, 120 to 160 mm, or 40 to 180 mm.

The mineral fiber wool mat may comprise
i. 90 to 98% by weight of mineral fiber component A, and
ii. 2 to 10% by weight of cured binder component B.

In the mineral fiber wool mat, the fibers may have a diameter in a range of from 3 to 10 μm.

The mineral fiber composite mat of the third aspect comprises x) the mineral fiber wool mat according to the second aspect, and y) one or more facing layers. These facing layers are preferably selected from i. the mineral fiber veil mat of the invention, ii. a paper layer, iii. a metal layer, and iv. a composite layer comprising paper and metal.

The mineral fiber mat, the mineral fiber veil mat, and the mineral fiber wool mat of the second aspect of the invention, or the mineral fiber composite mat of the third aspect of the invention, preferably
has fire protection according to DIN EN 13501:A1,
and/or (preferably and)
does not contain lignocellulosic particles.

According to the fourth aspect, the invention relates to the use of the mineral fiber mat, the mineral fiber veil mat, and the mineral fiber wool mat of the second aspect, or the mineral fiber composite mat of the third aspect, as or in a construction product, or in a transportation vehicle. The construction product is preferably selected from 1) floor sound and/or thermal insulation products and 2) roof sound and/or thermal insulation products.

The mineral fiber mat, as a mineral fiberwool mat or mineral fiber composite mat, preferably mineral wool mat, as product for sale may be in the form of a roll or sheet.

The mineral (mineral fiber wool mat) The mineral fiber mat (mineral fiber wool mat) may be used for insulation between or under rafters, in steep or flat roofs. The mineral fiber mat (mineral fiber wool mat) may also be used within an interior partition wall or as part of an industrial façade. Further alternatively, the mineral fiber mat (mineral fiber wool mat) may be used as or in floor insulation. When used in the insulation of outer walls, the mineral fiber mat (mineral fiber wool mat) may be used as core insulation sheet.

### Examples

### Materials

Dextrose monohydrate (>99%, Dextrose content=91%—“Dex”), Sigma Aldrich, Spain
Hydroxyacetone (HA, 95%), Alfa Aesar
Hexamethylene diamine (HMDA, >99%), Acros Organic
L-Lysine (98%), Sigma Aldrich, Switzerland
L-Lysine solution (50% in water), ADM animal nutrition, US
WHATMAN GF/A glass paper (glass veil with an area weight of ca. 52 g/m² made of glass microfibers with a diameter of ca. 4 μm and a length of ca. 3 mm)

The following examples are meant to further explain and illustrate the present invention, without limiting its scope.

The residual lysine monomer content is given as wt.-% monomer based on the total weight of polylysine including the lysine monomer. For instance, the 50 wt.-% solution of Polylysine with a lysine monomer content of 5.9 wt.-% contains 2.95 wt. % lysine monomer and 47.05% wt.-% lysine polymer comprising at least 2 condensed lysine units.

### Determination of Ratio of ε-Linkages to α-Linkages in Polylysine (“Ratio ε/α”):

This ratio ε/α is determined by integration of the signals for —CH—NH₂ and —CH—NH (α-linked) and —CH₂—NH₂ and —CH₂—NH (ε-linked) in the 1H-NMR spectra of the respective polylysines. The NMR signals are assigned by an 1H,15N-HMBC (Heteronuclear Multiple Bond Correlation) experiment.

### Preparation of Samples of Different Polylysines:

2200 g of L-lysine solution (50% in water, ADM) was heated under stirring in an oil bath (external temperature 140° C.). Water was distilled off and the oil bath temperature was increased by 10° C. per hour until a temperature of 180° C. had been reached. The reaction mixture was stirred for an additional hour at 180° C. (oil bath temperature) and the pressure was then slowly reduced to 200 mbar. After reaching the target pressure, distillation was continued for 120 min. The hot product was poured out of the reaction vessel, crushed after cooling, and dissolved in water, to give a 50 wt.-% solution of polylysine (PL).

Residual lysine monomer content, NCₚₛ and M_{w} were determined from this polylysine solution without any further purification. The residual lysine monomer content is given as wt.-% based on the total weight of polylysine including lysine monomer. The residual lysine monomer is included in the calculation of M_{w}. In these examples, the lysine monomer contributed a certain amount of amino groups to the binder.

$$\begin{matrix}{M}_{w} = 2010 g / mol \\ {NC}_{ps} = 10.5 w t . - \% \\ L - Lysine monomer content = 5.9 w t . - \%\end{matrix}$$

### Sample Preparation

Sheets of WHATMAN GF/A glass paper (glass veil with an area weight of ca. 52 g/m² made of glass microfibers with a diameter of ca. 4 μm and a length of ca. 3 mm) were impregnated with different binder mixtures, adding a total binder amount of 20% solid binder related to solid glass paper substrate (i.e. 10.5 g/m² solid binder per 52 g/m² glass microfibers). Drying and curing of the binder mixtures on the glass paper substrate was performed in a hot-air lab dryer (MATHIS-Ofen), applying a drying/curing temperature of both 170° C. (representing the “worst case” in industrial processes, e.g. temperature inside of dense and thick mats) and 200° C. (representing the usual dryer/goods temperature in industrial processes). After drying/curing and cooling to room temperature the following comparative tests were performed:
Tensile strength testing, done at room temperature by using a ZWICK tensile testing equipment—This characterizes the ability of the binder mixture to provide good fiber adhesion and bonding strength (note: the WHATMAN GF/A glass paper itself, i.e. without additional binder, has a tensile strength “close to zero”, i.e. has nearly no tensile strength at all).
Weight loss testing, done after 15 min treatment with boiling water (100° C.)—This characterizes the “wash-out” of the binder mixture, i.e. the ability of the binder mixture to get well-cured to a thermoset network structure having included low amounts of uncured or insufficiently cured, water-soluble components (note: the WHATMAN GF/A glass paper itself, i.e. without additional binder, has nearly no “wash-out”, i.e. does not contain significant portions of water-soluble components). Colour testing done according to EN ISO 11664-4 (“Colorimetry—Part 4: CIE 1976 L*a*b* Colour space”) by measurement of L* (perceptual lightness) and a* (green/red) and b* (blue/yellow).
L* characterizes the color brightness of the cured binder mixture, i.e. the color brightness of the binder-impregnated and cured product (note: the “WHATMAN GF/A glass paper” itself, i.e. without additional binder, shows nearly no “color darkness”) Darker products have lower L* values.

TABLE 1
Binder impregnated samples, dried/cured at 200° C. for 3 min.

| | | Ratio | Tensile | Weight loss | |
|---|---|---|---|---|---|
| | Binder | (solid/ | strength³ | 100° C./ | L* |
| Ex. | mixture | solid) | [N/5 cm] | 15 min, [%]⁴ | value |
| 1 | HMDA + | 15:85 | 98 | 7.7 | 54 |
| | Dex¹ | | | | |
| 2a | HMDA + | 25:75 | 104 | 4.0 | 58 |
| | Dex² | | | | |
| 2b | L + Dex | 25:75 | 107 | 8.6 | 54 |
| 2c | L + Dex | 50:50 | 111 | 12.2 | 57 |
| 2d | L + HA | 50:50 | 99 | 14.8 | 61 |
| 2e | L + HA | 75:25 | 108 | 28.2 | 66 |
| 3 | PL + Dex | 25:75 | 101 | 7.2 | 66 |
| 4 | PL + Dex | 50:50 | 104 | 1.6 | 66 |
| 5 | PL + HA | 50:50 | 104 | 1.6 | 74 |
| 6 | PL + HA | 75:25 | 104 | 1.6 | 79 |

¹Comparative example (WO2011/138458A, binder of example 3)
²Comparative example, deviating from the teaching of WO2011/138458A
³Maximum tensile force at break per width
⁴Based on total amount of cured binder mixture

From the test results (Table 1) it is apparent that, as compared to the binder constituents according to the prior art, there is an improvement in brightness (i.e. reduction in color darkness) when using amino acid polymer (polylysine), with otherwise comparable properties. When increasing the poly amino acid content in the binder mixture, weight loss is improved. A further increase in brightness is achieved when using hydroxyacetone instead of glucose. These results were confirmed by data obtained after curing at 170° C. (Table 2).

TABLE 2
Binder-impregnated samples, dried/cured at 170° C. for 3 min

| | | Ratio | Tensile | Weight loss, | |
|---|---|---|---|---|---|
| | Binder | (solid/ | strength³ | 100° C./ | L* |
| Ex. | mixture | solid) | [N/5 cm] | 15 min, [%]⁴ | value |
| 7 | HMDA + | 15:85 | 111 | 28.4 | 50 |
| | Dex¹ | | | | |
| 8a | HMDA + | 25:75 | 108 | 10.3 | 50 |
| | Dex² | | | | |
| 8b | L + Dex | 25:75 | 107 | 37.2 | 57 |
| 8c | L + Dex | 50:50 | 113 | 26.3 | 60 |
| 8d | L + HA | 50:50 | 83 | 75.5 | 61 |
| 8e | L + HA | 75:25 | 76 | 86.2 | 66 |
| 9 | PL + Dex | 50:50 | 111 | 7.9 | 61 |
| 10 | PL + HA | 50:50 | 97 | 2.4 | 67 |
| 11 | PL + HA | 75:25 | 97 | 6.9 | 73 |

¹Comparative example (WO2011/138458A, binder of example 3)
²Comparative example, deviating from the teaching of WO2011/138458A
³Maximum tensile force at break per width
⁴Based on total amount of cured binder mixture

When cured at 170° C., the improvement in weight loss when using the binder mixture of the present invention is apparently even more pronounced.

1.-19. (canceled)

20. A process for preparing a mineral fiber mat, the process comprising the following steps:
i. bringing mineral fibers selected from stone fibers, glass fibers, and mixtures thereof, in contact with a binder mixture comprising as binder constituents
c1) one or more amino acid polymers having two or more primary amino groups, and
c2) one or more alpha-hydroxy carbonyl compounds,
and
ii. curing the binder mixture at a temperature in a range of from 80 to 250° C., to give the mineral fiber mat.

21. A process for preparing a mineral fiber mat, the process comprising the following steps:
i. bringing mineral fibers selected from stone fibers, glass fibers, and mixtures thereof, in contact with a binder mixture comprising as binder constituents
c1) one or more amino acid polymers having two or more primary amino groups, and
c2) one or more alpha-hydroxy carbonyl compounds,
wherein the binder mixture comprises
binder constituent c1) in a total amount in the range of from ≥30 to ≤90 wt.-%, relative to the totalized weight of binder constituents c1) and c2), and
binder constituent c2) in a total amount in the range of from ≥10 to ≤70 wt.-%, relative to the totalized weight of binder constituents c1) and c2) and
ii. curing the binder mixture at a temperature in a range of from 80 to 250° C., to give the mineral fiber mat.

22. The process according to claim 20, wherein binder constituent c1) comprises one or more polylysines.

23. The process according to claim 22, wherein the one or more polylysines
have a weight-average molecular weight M_{w}, determined according to size exclusion chromatography (SEC), of ≥800 g/mol;
and/or
have a weight-average molecular weight M_{w}, determined according to size exclusion chromatography (SEC), of ≤10,000 g/mol;
and/or
have a weight-average molecular weight M_{w}, determined according to size exclusion chromatography (SEC), in the range of 800 g/mol≤M_{w}≤10000 g/mol;
and/or
comprise as monomers integrated in their polymer structure at least 85 wt.-% of lysine monomers;
and/or
wherein at least 50 wt.-% amino acids are used as monomers for the polymerization reaction based on the total amount of monomers forming the amino acid polymer(s) having two or more primary amino groups.

24. The process according to claim 20, wherein binder constituent c2) comprises one or more alpha-hydroxy carbonyl compounds selected from the group consisting of glycolaldehyde, glyceraldehyde, 1,3-dihydroxyacetone, hydroxyacetone, arabinose, xylose, glucose, mannose, and fructose.

25. The process of claim 20, wherein
the binder mixture comprises binder constituent c1) in a total amount in the range of from ≥40 to ≤85 wt.-% relative to the totalized weight of binder constituents c1) and c2), and/or
wherein the binder mixture comprises binder constituent c2) in a total amount in the range of from ≥15 to ≤60 wt.-% relative to the totalized weight of binder constituents c1) and c2), and/or
wherein the pH-value of the binder mixture is in the range of from 10 to 14.

26. The process of claim 20, wherein the binder mixture further comprises binder constituent c3) a carrier liquid.

27. The process of claim 20, wherein the binder mixture further comprises binder constituent c4) comprising one or more polyaldehyde compounds.

28. A mineral fiber mat comprising:
a mineral fiber component A comprising minerals fibers selected from stone fibers, glass fibers, and mixtures thereof, and
a cured binder component B prepared by curing, at a temperature in a range of from 80 to 250° C., of a binder mixture comprising as binder constituents
c1) one or more amino acid polymers having two or more primary amino groups and
c2) one or more alpha-hydroxy carbonyl compounds.

29. The mineral fiber mat of claim 28, having a density in a range of from 20 to 200 kg/m³.

30. The mineral fiber mat of claim 28, having a thickness in a range of from 1 to 300 mm.

31. The mineral fiber mat of claim 28, in the form of a mineral fiber veil mat having a thickness in a range of from 1 to 5 mm.

32. The mineral fiber veil mat of claim 31, comprising
i. 75 to 95% by weight of mineral fiber component A, and
ii. 5 to 25% by weight of cured binder component B.

33. The mineral fiber veil mat of claim 31, wherein the fibers have a diameter in a range of from 6 to 12 μm.

34. The mineral fiber mat of claim 28, in the form of a mineral fiber wool mat having a thickness in a range of from 10 to 250 mm.

35. The mineral fiber wool mat of claim 34, comprising
i. 90 to 98% by weight of mineral fiber component A, and
ii. 2 to 10% by weight of cured binder component B.

36. The mineral fiber wool mat of claim 34, wherein the fibers have a diameter in a range of from 3 to 10 μm.

37. A mineral fiber composite mat comprising
the mineral fiber wool mat of claim 34, and
one or more facing layers.

38. The mineral fiber mat of claim 28, the mineral fiber veil mat of claim 31, the mineral fiber wool mat of claim 34, or the mineral fiber composite mat of claim 37, having fire protection according to DIN EN 13501:A1.

39. The mineral fiber mat of claim 28, the mineral fiber veil mat of claim 31, the mineral fiber wool mat of claim 34, or the mineral fiber composite mat of claim 37, for a construction product, or in a transportation vehicle.
